(19) United States
(12) Patent Application Publication
(10) Pub. No.: US 2005/0013921 A1
(43) Pub. Date: Jan. 20, 2005

(54) Novel multi-component garlic food supplement

(76) Inventor: Andrea Lynn Peticca, Miami, FL (US)

Correspondence Address: Andrea Lynn Peticca, PMB #309, 850 Ives Dairy Road, Miami, FL, 33179, US

(21) Appl. No.: 10/620,915

(22) Filed: Jul. 17, 2003

(51) Int. Cl. A23L 1/168

(52) U.S. Cl. 426/619

(57) ABSTRACT

This unique garlic food supplement product contains a synergistic combination of natural food ingredients giving a garlic effectiveness greater than provided by the presently commercially available garlic products including tablets, capsules, oils, powders, liquids and extracts. This unique combination of powdered garlic, neutralized vinegar, olive oil, and honey may be prepared as a tablet, capsule, powder, oil, or semi-liquid, depending on the ratios of individual components. The neutralized vinegar combined with garlic is synergistic for increasing the effectiveness of garlic for safe weight reduction. In addition, the product is believed to give a significant lowering of blood pressure and assisting the body in the alleviation of inflammation of joints and of numerous other disorders which have been reported for garlic itself. The use of sugars (sucrose, glucose, and fructose), e.g. from honey, gives a longer shelf-life and a satisfactory masking of the strong garlic flavor and odor.

This synergistic herbal mixture is made by thoroughly mixing the following pure components:
(1) Dried powdered garlic with high allicin content.
(2) Apple cider vinegar neutralized with coral calcium, calcium carbonate, dolomite, magnesium carbonate, sodium hydroxide or any other basic food grade mineral. (However, coral calcium is highly recommended due to the higher degree of assimilation of calcium and magnesium plus the trace metals present.)
(3) Olive oil or other vegetable oil to assist in the assimilation of the garlic components to be assimilated.
(4) Honey for flavoring and assisting assimilation of garlic components.

The weight ratio of the four components 1/2/3/4 can vary from 1/1/1/1 to any other desired ratio but the level of garlic should be used at a somewhat higher level. The mixture can be made into a fine powder for use in tablets or capsules or can be made into a gel or liquid for other types of products.

### CROSS-REFERENCES TO RELATED APPLICATIONS

One patent reference related to the present marinade was found in a 20 year search of the U.S. Patent and Trademark Office patents.

### BACKGROUND OF THE INVENTION

1. Field of the Invention

This invention relates to a multi-component powder or liquid garlic food supplement having a unique combination of two natural products found to be effective in assisting the body's metabolism and repair mechanisms which promote weight loss and assist the body with several types of diseases and disorders.

2. Description of the Related Art

No combinations of garlic with neutralized vinegar have been described. In the most effect embodiment, honey and vegetable oil are also added. No similar products have ever been described, developed or patented. Many food supplements contain garlic plus some other ingredients but none have been developed which have the unique properties of this product which promotes good health, safe weight loss, and other benefits.

### SUMMARY OF THE INVENTION

The present invention is directed to a combination of two traditionally used health foods: garlic and vinegar. In this preparation the vinegar is neutralized and converted to a fine powder, which is basic or neutral. This combination of garlic and basic vinegar has been found to be synergistic for weight loss. Olive oil is added to help in the assimilation of the first two ingredients and to improve the flavor. The use of honey or other sugar product helps to improve the flavor, to preserve the flavors and to retard spoilage.

1. This multi-component garlic product consists of a unique synergistic combination of garlic powder and neutralized vinegar plus honey and olive oil found to be effective as a food supplement.

2. This product, unlike all other garlic products, contains a neutralized apple cider vinegar plus olive oil and honey. The basic or neutral vinegar as well as the olive oil and honey, enhance the beneficial properties of garlic as well as give the garlic a more palatable flavor and odor.

3. This product, compared to all other garlic products, gives a much more significant weight loss benefit and lowers the acidity of the body, which promotes better health.
